(19) United States
(12) Patent Application Publication
(10) Pub. No.: US 2012/0284696 A1
(43) Pub. Date: Nov. 8, 2012

(54) Method, Apparatuses and a System for Compilation

(75) Inventor: Janne Koskinen, Lempaala (FI)

(73) Assignee: NOKIA CORPORATION, Espoo (FI)

(21) Appl. No.: 13/515,961

(22) PCT Filed: Dec. 21, 2009
(86) PCT No.: PCT/FI09/51026

§ 371 Date: Jul. 11, 2012

(51) Int. Cl. G06F 9/45; G06F 9/44; G06F 9/445

(52) U.S. Cl. 717/126; 717/140

(57) ABSTRACT

The invention relates to forming a binary computer program. Target platform information is provided to a compiler, as well as source code. A compilation environment is then determined based on the platform information and a binary computer program is formed from the source code for the target platform in the compilation environment.

### BACKGROUND

Current embedded devices may have hundreds of megabytes of memory and a fast processor, as well as versatile capabilities in graphics, image and video capture and sound processing, and of course communications. Developing software for such devices can be a highly demanding task, even with the help of good development tools.

There is, therefore, a need for solutions that make it easier and faster to develop software for versatile computing devices.

### SUMMARY

Now there has been invented an improved method and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments are disclosed in the dependent claims.

Information on the target platform of the binary program is provided to a server so that the compilation may happen appropriately and the right target binary may be created. The server may provide a template for the user to use when the user is creating the source code. The accompanying target platform information is used to select the right compilation environment, and the binary is produced for the right target platform, when the source code is sent to the server for compilation. The binary code may be tested, and an installation package may be created. In this manner, the user may avoid installation of at least some of the components of a development environment, which may make it easier to start and carry out development for a specific target platform.

According to a first aspect there is provided a method for forming a binary computer program comprising accessing target platform information at a compiler apparatus on a first communication interface, the target platform being external to said compiler apparatus, accessing source code at a compiler apparatus on a second communication interface, determining a compilation environment based on said platform information, forming a binary computer program from said source code for said target platform using said compilation environment, and providing said binary computer program for said target platform available on a third communication interface.

According to an embodiment, the method comprises providing a source code template available on the second communication interface based on the target platform information. According to an embodiment, the method comprises forming an installation package for the target platform using the binary computer program, signing the installation package using the target platform information, and providing the signed installation package available on the third communication interface. According to an embodiment, the method comprises determining a testing environment based on the target platform information for testing the binary computer program testing the binary computer program for correct operation of installation, launch, input and output and/or user interface operation. According to an embodiment, the method comprises providing the testing environment at least partially available on communication interface to a developer computer so that the testing environment receives input from the developer computer and provides output to the developer computer. According to an embodiment, the compilation environment comprises a virtual machine, a physical machine, a compiler installation and/or a compiler setup. According to an embodiment, the method comprises the first communication interface is an interface between the compiler apparatus and a developer computer, such as a personal computer or a mobile phone, the second communication interface is an interface between the compiler apparatus and a source code storage apparatus such as a network memory device, an internal memory device, an external memory device or a developer computer, and the third communication interface is an interface between the compiler apparatus. According to an embodiment, the first communication interface and the second communication interface are interfaces between the compiler apparatus and a development environment at a development computer, and the source code is provided by the development environment to the compiler apparatus by transmitting a source code file from the development computer to the compiler apparatus.

According to a second aspect there is provided an apparatus comprising at least one processor, memory including computer program code, the memory and the computer program code configured to, with the processor, cause the apparatus to access target platform information at a compiler apparatus on a first communication interface, the target platform being external to the compiler apparatus, access source code at a compiler apparatus on a second communication interface, determine a compilation environment based on the platform information, form a binary computer program from the source code for the target platform using the compilation environment, and provide the binary computer program for the target platform available on a third communication interface.

According to an embodiment, the apparatus comprises computer program code configured to, with the processor, cause the apparatus to provide a source code template available on the second communication interface based on the target platform information. According to an embodiment, the apparatus comprises computer program code configured to, with the processor, cause the apparatus to form an installation package for the target platform using the binary computer program, sign the installation package using the target platform information, and provide the signed installation package available on the third communication interface. According to an embodiment, the apparatus comprises computer program code configured to, with the processor, cause the apparatus to determine a testing environment based on the target platform information for testing the binary computer program, test the binary computer program for correct operation of installation, launch, input and output and/or user interface operation. According to an embodiment, the apparatus comprises computer program code configured to, with the processor, cause the apparatus to provide the testing environment at least partially available on communication interface to a developer computer so that the testing environment receives input from the developer computer and provides output to the developer computer. According to an embodiment, the compilation environment comprises a virtual machine, a physical machine, a compiler installation and/or a compiler setup. According to an embodiment, the first communication interface is an interface between the compiler apparatus and a developer computer, such as a personal computer or a mobile phone, the second communication interface is an interface between the compiler apparatus and a source code storage apparatus such as a network memory device, an internal memory device, an external memory device or a developer computer, and the third communication interface is an interface between the compiler apparatus. According to an embodiment, the first communication interface and the second communication interface are interfaces between the compiler apparatus and a development environment at a development computer, and the compiler apparatus is configured to receive the source code from the development environment by receiving a source code file from the development computer to the compiler apparatus.

According to a third aspect there is provided a system comprising at least one computer, the computer comprising at least one processor, memory including computer program code, the memory and the computer program code configured to, with the processor, cause the system to access target platform information at a compiler apparatus on a first communication interface, the target platform being external to the compiler apparatus, access source code at a compiler apparatus on a second communication interface, determine a compilation environment based on the platform information, form a binary computer program from the source code for the target platform using the compilation environment, and provide the binary computer program for the target platform available on a third communication interface.

According to an embodiment, the system comprises computer program code configured to, with the processor, cause the system to provide a source code template available on the second communication interface at the compiler apparatus based on the target platform information and receive and store the source code template at a development apparatus. According to an embodiment, the system comprises computer program code configured to, with the processor, cause the system to form an installation package for the target platform using the binary computer program, sign the installation package using the target platform information, and provide the signed installation package available on the third communication interface at the compiler apparatus. According to an embodiment, the system comprises computer program code configured to, with the processor, cause the system to determine a testing environment based on the target platform information for testing the binary computer program, and, at a testing apparatus, test the binary computer program for correct operation of at least one of the group of installation, launch, input and output and user interface operation, wherein the testing apparatus is operatively connected to a device having an operating system as determined by the target platform information.

According to a fourth aspect there is provided an apparatus comprising at least one processor, memory including computer program code, the memory and the computer program code configured to, with the processor, cause the apparatus to provide target platform information available for a compiler apparatus on a first communication interface, the target platform being external to the compiler apparatus, receive a source code template, the template having been formed based on the target platform information, form source code using the source code template and provide the source code available for a compiler apparatus on a communication interface, and receive a binary computer program formed from the source code for the target platform, the binary computer program having been formed by determining the target platform based on the target platform information.

According to a fifth aspect there is provided an apparatus comprising means for accessing target platform information on a first communication interface, the target platform being external to the apparatus, means for accessing source code on a second communication interface, means for determining a compilation environment based on the platform information, means for forming a binary computer program from the source code for the target platform using the compilation environment, and means for providing the binary computer program for the target platform available on a third communication interface.

According to a sixth aspect there is provided a network service providing to a user: uploading target platform information at a compiler apparatus on a first communication interface, the target platform being external to the compiler apparatus, uploading source code at a compiler apparatus on a second communication interface, determining a compilation environment based on the platform information, forming a binary computer program from the source code for the target platform using the compilation environment, and providing the binary computer program for the target platform available on a third communication interface.

According to a seventh aspect there is provided a computer program product stored on a computer readable medium and executable in a data processing device, wherein the computer program product comprises a computer program code section for accessing target platform information at a compiler apparatus on a first communication interface, the target platform being external to the compiler apparatus, a computer program code section for accessing source code at a compiler apparatus on a second communication interface, a computer program code section for determining a compilation environment based on the platform information, a computer program code section for forming a binary computer program from the source code for the target platform using the compilation environment, and a computer program code section for providing the binary computer program for the target platform available on a third communication interface.

According to a eighth aspect there is provided a computer program product stored on a computer readable medium and executable in a data processing device, wherein the computer program product comprises a computer program code section for providing target platform information available for a compiler apparatus on a first communication interface, the target platform being external to the compiler apparatus, a computer program code section for receiving a source code template, the template having been formed based on the target platform information, a computer program code section for forming source code using the source code template and provide the source code available for a compiler apparatus on a communication interface, and a computer program code section for receiving a binary computer program formed from the source code for the target platform, the binary computer program having been formed by determining the target platform based on the target platform information.

### BRIEF DESCRIPTION OF THE DRAWINGS

In the following, various embodiments of the invention will be described in more detail with reference to the appended drawings, in which

FIG. 1a shows a flow chart of a method for compiling according to an example embodiment;

FIG. 1b shows an arrangement for compiling according to an example embodiment;

FIG. 2a shows a system for development, compiling and testing a computer program according to an example embodiment;

FIG. 2b shows devices for development, compiling and testing a computer program according to an example embodiment;

FIGS. 3a and 3b show a compilation environment according to an example embodiment;

FIG. 4 shows a signaling and operations diagram for development, compiling and testing a computer program according to an example embodiment;

FIG. 5 shows a flow chart for development, compiling and testing a computer program according to an example embodiment;

FIG. 6a shows a testing arrangement for testing a computer program according to an example embodiment;

FIG. 6b shows a flow chart for testing a computer program according to an example embodiment;

FIGS. 7a and 7b show a development environment according to an example embodiment;

FIG. 8a shows a structure of a binary program according to an example embodiment; and

FIG. 8b shows a structure of an installation package according to an example embodiment.

### DESCRIPTION OF EXAMPLE EMBODIMENTS

In the following, several embodiments of the invention will be described in the context of a compiler residing at a remote location from the development computer. It is to be noted, however, that the invention is not limited to compilation servers. In fact, the different embodiments have applications widely in any environment where platform-specific processing of data or code and creation of platform-specific data or binary code is required.

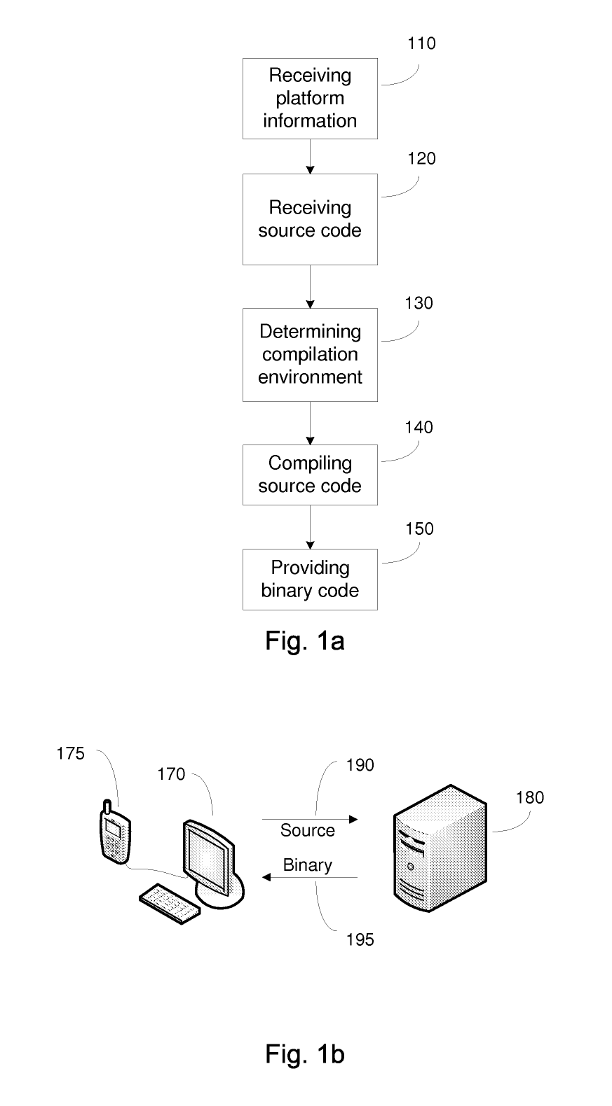

FIG. 1a shows a flow chart of a method for compiling a software code according to an example embodiment. In 110, information on the target platform is received. The target platform may comprise, for example, an operating system and operating system version of the device for which the software is being developed, as well as the capabilities and settings of the device, for example, screen resolution, audio and video capabilities, instruction set, and possibly identifying data like the device identifier or the subscriber identifier. In 120, the source code to be compiled is received. The source code may be complete and ready for compilation, or it may comprise only essential sections of the source code, while the rest may be fetched from internal memory of the compiler device or from another source. A proper compilation environment is determined in 130, based on the target platform. This compilation environment has a compiler set up in such a manner that it produces binary code suitable for the target platform, and has, for example, all the necessary libraries available. The source code is compiled to binary code in 140, for example, the source code that is at least partly readable by a human being is compiled to a format that can be used by the processor of the target platform, for example, is computer-readable. The term “binary code” is not to be understood to be restricted to code that is not readable by humans, but is merely chosen to indicate any code that is formed from a source code and can be used by a computer processor. The binary code is then delivered in 150 to be used at the target platform, for example, back to the sender of the source code.

FIG. 1b shows an arrangement for compiling according to an example embodiment. The developer uses a computer 170 for developing a program. The developer may also have a device 175 for which the program is being developed (the target device), or a resembling device. The device 175 may be attached to the computer 170. There is also a compilation server 180 the network and being communicably connected to the developer computer 170. The compilation server 180 comprises at least some of the means for compiling a source code 190 from the computer 170 into a binary code 195. The binary code 195 may be returned to the computer 170 or it may be made available to the user by some other means, for example, by storing it in the network and providing a link of location storing the binary code.

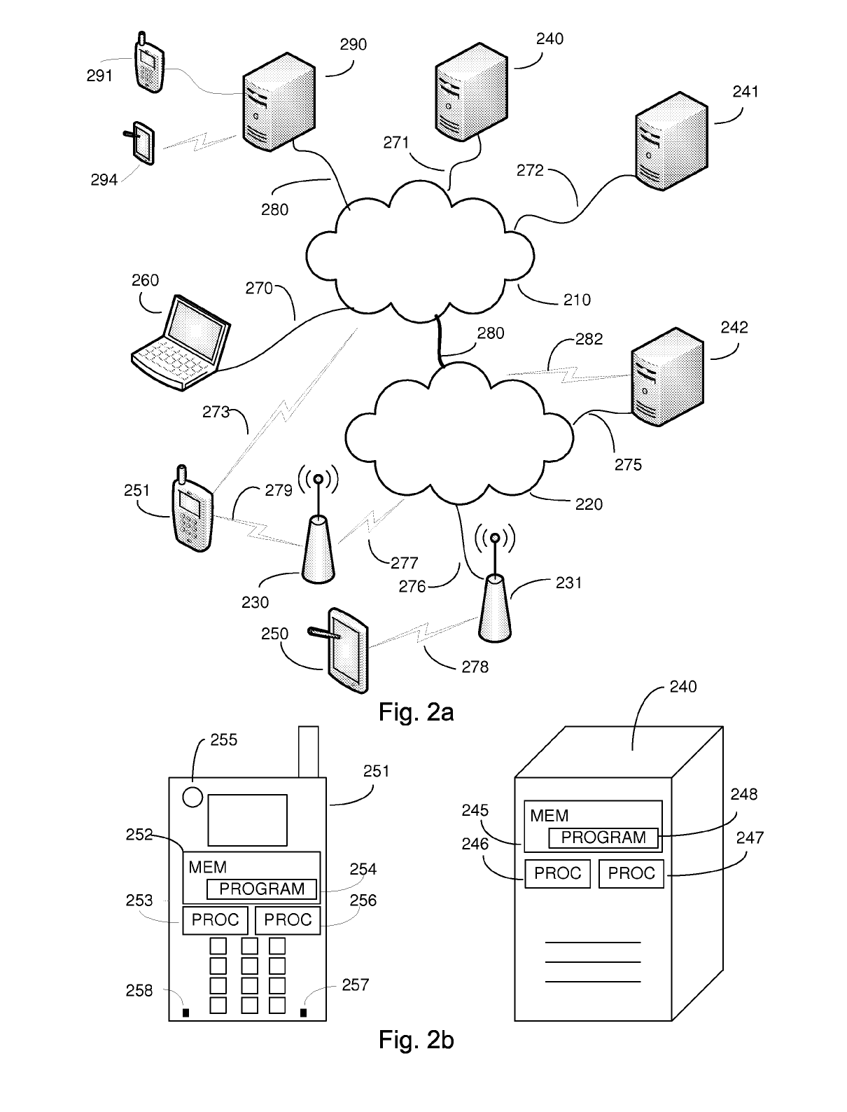

FIG. 2a shows a system for development, compiling and testing a computer program according to an example embodiment. The different devices are connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There are a number of servers connected to the network, and here are shown a server 240 for compiling source code and connected to the fixed network 210, a server 241 for storing program data and/or source code and connected to either the fixed network 210 or the mobile network 220 and a server 242 for compiling source code and connected to the mobile network 220. There are also a number of computing devices 290 connected to the networks 210 and/or 220 that are there for storing data and providing access to the data via, for example, a web server interface or data storage interface or such, and for providing access to other devices. Some of the above devices, for example the computers 240, 241, 242, 290 may be such that they make up the Internet with the communication elements residing in the fixed network 210. Some of the computing devices may provide access to test devices 291 over a fixed connection like a Universal Serial Bus (USB), FireWire or a serial or a parallel connection, optical connection or any other type connection, and to test devices 294 over a wireless connection like a Wireless Local Area Network (WLAN) connection or a Bluetooth® connection.

There are also a number of end-user devices such as mobile phones and smart phones 251, Internet access devices (Internet tablets) 250 and personal computers 260 of various sizes and formats. These devices 250, 251 and 260 can also be made of multiple parts. The various devices are connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 2b shows devices for development, compiling and testing a computer program according to an example embodiment. As shown in FIG. 2b, the server 240 contains memory 245, one or more processors 246, 247, and computer program code 248 residing in the memory 245 for implementing, for example, compiler functionality. The different servers 241, 242, 290 may contain at least these same elements for employing functionality relevant to each server. Similarly, the end-user device 251 contains memory 252, at least one processor 253 and 256, and computer program code 254 residing in the memory 252 for implementing the compiler functionality. The end-user device may also have at least one camera 255 for taking pictures. The end-user device may also contain one, two or more microphones 257 and 258 for capturing sound. The different end-user devices 250, 260 may contain at least these same elements for employing functionality relevant to each device. Some end-user devices may be equipped with a digital camera enabling taking digital pictures, and one or more microphones enabling audio recording during, before, or after taking a picture.

It needs to be understood that different embodiments allow different parts to be carried out in different elements. For example, the compilation may be carried out entirely in one user device like 250, 251 or 260, or the compilation may be entirely carried out in one server device 240, 241, 242 or 290, or the compilation may be carried out across multiple user devices 250, 251, 260 or across multiple network devices 240, 241, 242, 290, or across user devices 250, 251, 260 and network devices 240, 241, 242, 290. The compilation can be implemented as a software component residing on one device or distributed across several devices, as mentioned above, for example so that the devices form a so-called cloud. The compilation may also be a service where the user accesses the compilation service through an interface, for example, using a browser.

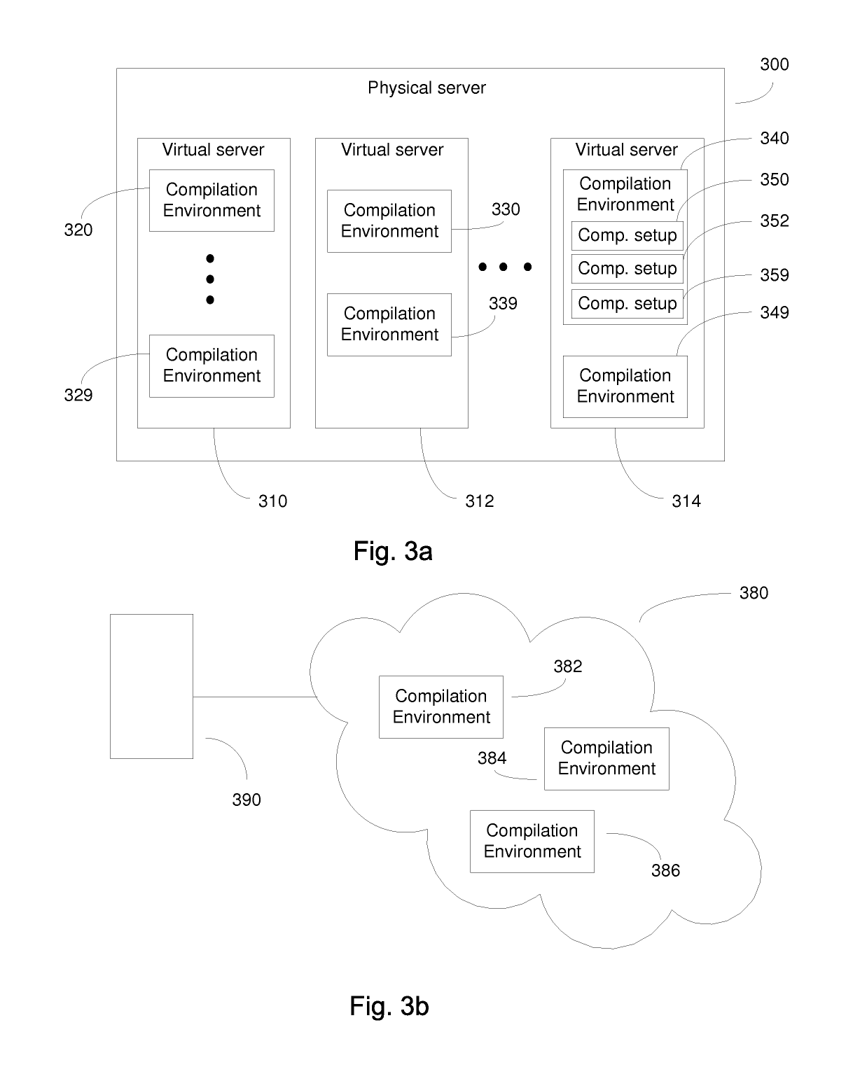

FIGS. 3a and 3b show a compilation environment according to an example embodiment. In FIG. 3a, the compilation system 300 resides on a single computer (server), or it may reside on a cluster of computers forming a single server entity. The server may comprise virtual machines 310, 312 and 314, each being a server installation of its own, created on top of the physical computer or a cluster of computers. The virtual servers may host different operating systems, for example server 310 may have a Microsoft Windows® operating system, the server 312 may have an Apple OSX® operating system and the server 314 may have a Linux operating system.

The virtual machines and the physical server machine may each have installations of a compilation environment such as the compilation environments 320 to 329 in virtual server 310, the compilation environments 330 to 339 in virtual server 312 and the compilation environments 340 to 349 in virtual server 314. A compilation environment is arranged to be capable to create binary code for a certain target platform or a range of target platforms. It needs to be appreciated that the different compilation environments may be different from each other, or they may be the same. For example, each virtual server may host the same set of different compilation environments, or each virtual machine may have multiple compilation environments of one kind and different virtual machines may then have different compilation environments between the virtual machines.

A compilation environment may have different compilation environment setups for creating binary code for a specific target platform or a range of target platforms. For example, as shown in FIG. 3a, the compilation environment 314 in the virtual machine 340 may have compilation setups 350, 352 and 359. Any other compilation environment, whether inside a virtual machine or on top of a physical machine, may have such compilation setups.

FIG. 3b shows an arrangement where the compilation environments are provided by a cloud computing setup 380. In such a setup, or generally any setup where a certain service is not bound to a specific hardware in a fixed manner, the different compilation environments 382, 384 and 386 may be provided to be directly visible to a user as a service. The compilation environments and compilation setups described in the context of FIG. 3a may be transformed to be individually accessible to a user. Thereby, the user may only need to request from his/her development computer 390 for a certain compilation setup to be available, and the cloud provides such a setup to be available.

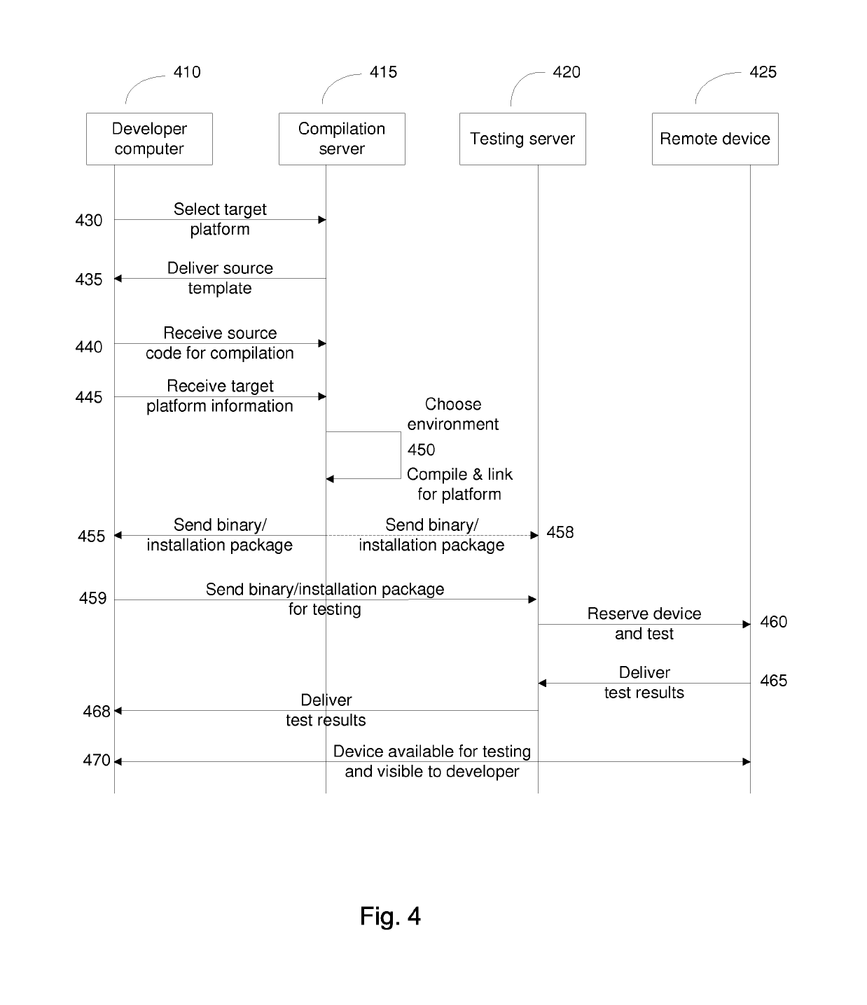

FIG. 4 shows a signaling and operations diagram for development, compiling and testing a computer program according to an example embodiment. The system comprises a developer computer 410, a compilation server or service 415, a testing server or service 420 and a remote device 425. The functionalities of these entities may be shared, for example, the compilation server 415 and the testing server may be a single entity. The functionalities may also be distributed differently than what is shown in this diagram. For example, the developer machine 410 may comprise a number of features from the compilation server 415 whereby they may not be needed at the compilation server 415.

In the following, the different steps and signals related to compiling a program are described. These steps may be omitted or combined, or arranged in a different order, as permitted by feasible operation of the system. A target platform is selected and communicated from the developer computer to the compilation server in 430. The selection may happen by choosing from a set of available target platforms, or it may happen by choosing a set of target platform parameters describing the capabilities of the target platform. The communication may happen so that the information is packaged in a communication package and transmitted to the compilation server 415, or it may happen interactively, e.g. through a web service using a web browser at the developer computer 410 to post the information to the server 415.

Next, a source template may be formed in 435. The source template may comprise, for example, skeleton source code files where a developer can easily create the specific source code of the application without needing to worry about all definitions since such are provided in the template. The source code template may also comprise user interface definitions or even example snippets of code for easy development. The source template may be packaged and sent to the developer machine, or it may be made available by other means, for example, through network to the developer machine. In the latter case, a link to the source code template may be provided to the developer machine.

After developing the source code, the developer may in 440 choose to deliver the source code or make the source code otherwise available to the compilation server 415. The source code may be packaged to a communication package and sent to the server, or it may be made available at another location to the server so that the server may access the source code over a communication interface. In connection with the source code, target platform information and definitions may be delivered to the compilation server 415 in 445. The target platform information may be the same that was received from the compilation server earlier, or it may be independently formed, or it may be a modified and/or supplemented version of the target platform information received from the compilation server 415.

At point 450, when the compilation server 415 has access to the source code and the target platform information, the compilation server 415 may choose or configure a compilation environment for creating the binary code based on the target platform information. This selection of the compilation environment and/or setup may happen as explained in context of FIGS. 3a and 3b. After choosing the compilation environment, the server takes the source code and compiles it into binary code that may already be executable by the target platform processor. Forming the binary code may also comprise linking the binary code created from the source code with the appropriate libraries for the target platform, for example input/output libraries, graphics libraries and such. The linking may be static or dynamic, as generally understood by a skilled person. The forming of the binary code may also comprise creating an installation package where the compiled and possibly linked binary code and appropriate data and libraries are packaged into an installation package. Such an installation package may be ready for installation at the target platform. The installation package may be digitally signed so that the target platform may verify the origin of the installation package in order to trust the source and allow or recommend installation.

At point 455, the binary code may be delivered to the developer machine so that it may be installed to the target platform. The binary code may be sent to the testing server 420 for testing, if the developer wishes to continue development by testing the created binary code. This may happen so that the binary code is delivered or made accessible to the testing server directly by the compilation server at 458, or so that the developer sends or makes the binary code accessible to the testing server at 459. If the compilation and testing server are unified, such sending may be simplified or may not be done at all.

The testing server 459 may reserve an appropriate remote device for testing the code at 460, when the testing server receives 459 a binary code for testing. The reservation may happen automatically in response to receiving a testing request, or the testing server may allow booking a testing time slot by the developer. The testing server may also propose a testing time slot, for example, in the case that no testing devices are available instantaneously. The testing server may store the binary code in the memory until then, or it may be necessary to make the binary code available to the testing server at the time of the testing, if the testing is scheduled for a later time. The testing device or remote device is operatively connected to the testing server, for example, by a wireless or a wired connection, as explained earlier, and the operation of the remote device may be recorded by the testing server. The remote device may also provide monitoring results or results of test scripts to the testing server at 465. Such test results and monitoring results by the testing server may be delivered or made accessible to the developer machine at 468.

Testing the operation of the binary code at 470 may happen so that the testing device interface is made available to the developer over a data connection. The developer is therefore able to observe what happens on the screen of the remote device, and is able to communicate key presses or even touch screen operations to the remote device. A log of the input and output may be formed, showing the input given to the remote device, possibly the status changes of the remote device as well as the output of the remote device. Testing may also happen automatically, for example, in connection to point 450, or automatic testing may be requested by the developer. For example, testing of installation, launch of the binary code, power consumption, processor load, execution speed, screen output and sensor data of the device may be done automatically.

The test devices may be actual, real devices like mobile phones or computers. The test devices may also be virtual, for example, computer-modeled devices. The test devices may also be integrated devices, where part of the test device is real and part of the test device is a modeled device.

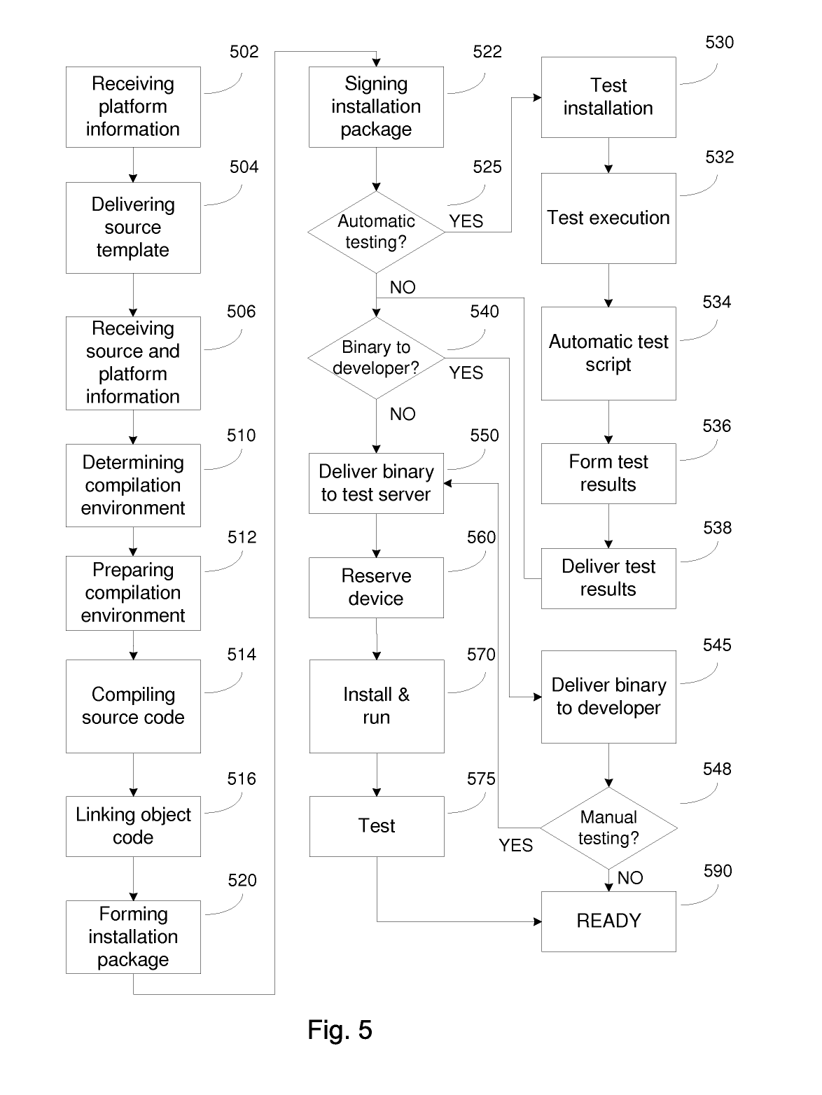

FIG. 5 shows a flow chart for development, compiling and testing a computer program according to an example embodiment. In 502, information on the target platform is received. The target platform may comprise, for example, the operating system and operating system version of the device for which the software is being developed, as well as the capabilities and settings of the device, for example, screen resolution, audio and video capabilities, instruction set, and possibly identifying data like the device identifier or the subscriber identifier. At least partially based on this information on the target platform, a source template may be delivered to the development computer at 504. The source template may comprise source code, definitions, for example user interface definitions, data, images, sounds and even examples for creating a project for the target platform.

In 506, the source code to be compiled is received. The source code may be complete and ready for compilation, or it may comprise only essential sections of the source code, while the rest may be fetched from internal memory of the compiler device or from another source. With the source code, definitions of the target platform, e.g. the target platform name and settings, may be received. A proper compilation environment is determined in 510, based on the target platform. This compilation environment has a compiler set up in such a manner that it produces binary code suitable for the target platform, and has for example all the necessary libraries available. The compilation environment may be set up in 512 by choosing and activating the environment and/or defining parameters of compilation.

The source code is compiled to binary code in 514, for example, the source code that is at least partly readable by a human being is compiled to a format that can be used by the processor of the target platform, for example, is computer-readable. The term “binary code” is not to be understood to be restricted to code that is not readable by humans, but is merely chosen to indicate any code that is formed from a source code and can be used by a computer processor. The compilation may produce so-called object code, a form of binary code. The object code or the binary code may be linked with libraries and other source files like data to form an executable file in 516. The executable file may then, possibly with other files be packaged to an installation package or multiple installation packages in 520. The installation package may be signed in 522 for the target platform to indicate the source of the package.

An automatic testing routine is commenced in 525, if automatic testing of the binary code is determined to be done. In an automatic testing routine, the installation of the installation package or other form of binary code may be tested in 530. The execution or launch of the binary code may be tested at 532 when the binary code has been installed on the test device. When the binary code is running, an automatic test script may be carried out in 534, whereby the test script invokes functions of the binary code by providing input to the binary code and the resulting output is monitored and logged. Other parameters and conditions like processor utilization, memory utilization, power consumption, temperature and screen utilization may be monitored and logged. Based on the monitoring and logging, a set of test results may be formed in 536 and delivered in 538.

If it is determined at 540 that the binary code is ready to be delivered to the developer, the binary code is sent or otherwise made available over a communication interface to the developer at 545. Otherwise, the binary code may be provided available to a test server at 550.

If manual testing of the binary code is determined to be done at 548, an automatic testing routine is commenced. The binary code is provided available to a test server at 550. This may happen by sending the binary code to the test server or providing the test server with access to the binary code at a specified address. In a manner described earlier, a test device may then be reserved for testing in 560. The binary code may then be installed on the test device and launched in 570. As described earlier, the developer may be able to observe the operation of the test device over a data connection in 575 when testing is carried out. During testing a log may be produced of the input and output of the test device, as well as different conditions of the test device like processor utilization, memory utilization, power consumption, and temperature and screen utilization.

The procedure ends when the developer has access to the binary code at 590 and the possibly desired testing procedures have been carried out.

In a so-called minimal solution, a user may not need to setup anything on the development machine to be able develop a program for the target platform, for example, the Symbian platform. A web service may be implemented where a user can choose the target device platform and download skeleton project for the chosen platform. Then user may then develop the application and compile it using the web service which enables back-end compilation. After successful compilation, the user may also have an option to run the binary code in a remote device with the help of a testing service such as the Forum Nokia RDA. The benefit of this may be that a user may not need other software than a text editor like a notepad and web browser like the Internet explorer on the development computer. In such a case, development may be possible even using a mobile device such as a smart phone or even a regular mobile phone.

In minimal solution only a web back-end service may need to be implemented. This can be done various ways. One possibility is to have a physical or virtual machine with a Windows operating system where we a Perl script enabled Web server such as an Apache web server is installed. The web server offers a web page with a form where a user can select the target platform and post the selection to the server. After that, the web server may allow a user to download a skeleton project or the skeleton project may be pushed to the user, or made available through a link at the same server or at another server.

Compilation can be implemented so that web page includes a form that the user can use to upload the completed project as a compressed or combined package like a ZIP package. The back-end server's Perl script then unpacks the package, checks the target platform and selects the correct environment from the back-end server and compiles the source code. Different development and compilation environments may be installed to the back-end server. The compilation produces a log file and an installation package, for example, in SIS format. The user may be able to see the log from a web page and then download an installation package containing the resulting binary code.

Optionally, after a successful compilation, the back-end server may give the user a possibility to test the binary code application in a real remote device e.g. by using a testing service such as the Forum Nokia RDA service.

In a so-called enhanced solution a user may install only the development environment such as the Carbide C₊₊ environment on the development computer. A web service plug-in for the development environment may be created and made available to the developer which enables possibility to use backend compilation, e.g. with one button press. With this solution, a user may be able to use a development tool as usual, but complex environments may be installed to the back-end server or service instead of the development computer. This makes the installation and use of a development environment lighter.

The plug-in may be created by using a plug-in framework of the development environment. For example, a Carbide C₊₊ plug-in may be implemented by using the Eclipse plug-in development environment. The created plug-in may then be used to create a source code package like a compressed ZIP file directly from the development user interface and to send the package to the back-end server to be compiled.

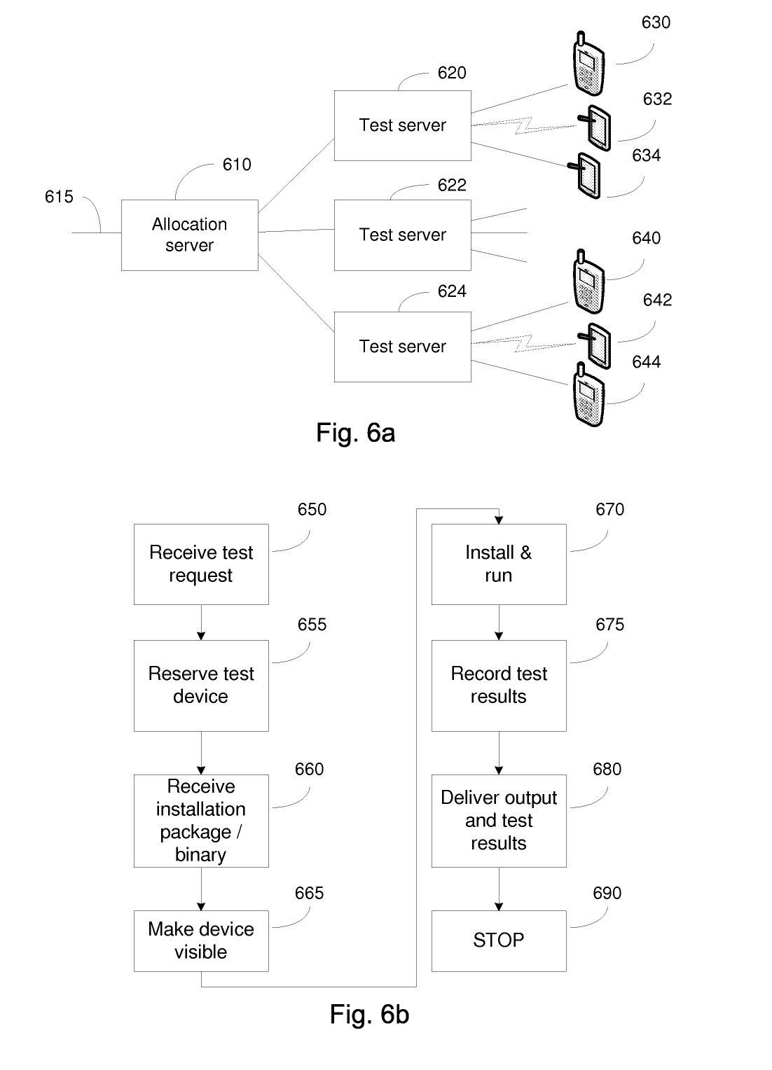

FIG. 6a shows a testing arrangement for testing a computer program according to an example embodiment. There may be a front-end server or an allocation server 610 that receives incoming testing requests from a communication interface 615. Operatively connected to the allocation server 610, or to the communication interface 615, there may be a number of test servers 620, 622 and 624. These test servers may comprise debugging and logging software and means for communicating with attached test devices. There may be a number of test devices such as the test devices 630, 632 and 634 connected to the test server 620 and the test devices 640, 642 and 644 connected to the test server 624. The test devices may have a different software platform and they may have different capabilities, or the test devices may be similar to each other, or some test devices may be different and some similar. The connections between the test servers and the test devices may be wired or wireless, as explained earlier, for example over a WLAN or Bluetooth® connection or a USB or a FireWire connection. The test servers may also be omitted if the test device provides means for running the test device in a test mode, for example, by logging the operations of the test device.

FIG. 6b shows a flow chart for testing a computer program according to an example embodiment. A test request is received e.g. from the development computer or from the compiler server in 650. The test request may comprise a binary code package for testing, or the request may indicate where such a binary code can be found for access over a communication interface. In response to the test request, the test server may reserve a test device (remote device) for testing in 655. Such a reservation may be immediate, or in the case that no test devices are available, it may be a reservation in the future. There may also be a request for a test time in the test request, in which case the server may reserve the test device according to the test time. An installation package for testing may be received next in 660 or such may be received already in the test request. The receiving may happen in the form of receiving a communication package from a communication interface, for example by uploading a file to the test server via a web interface.

The test server may now set up the test, having received the binary code for testing and having reserved a test device. The test server may make the test device visible to the developer in 665 e.g. over a video connection, or a data connection able to transfer images and other data, or by another data connection. The test server may then install and run (execute) the binary code on the test device in 670. During execution, the test server and/or the test device may record the input, output and operational parameters of the test device in 675. This may be done instead of or in addition to making the test device visible to the developer. The test server may then deliver 680 the output to the developer computer, e.g. by sending a log of the testing session or by continuously sending data to the developer computer. When testing is ready, the test server stops 690 the test routine and may initialize the device to its normal state. The test set-up described above may be interactive so that the developer requests testing, or it may be automatic e.g. so that the compilation server requests testing.

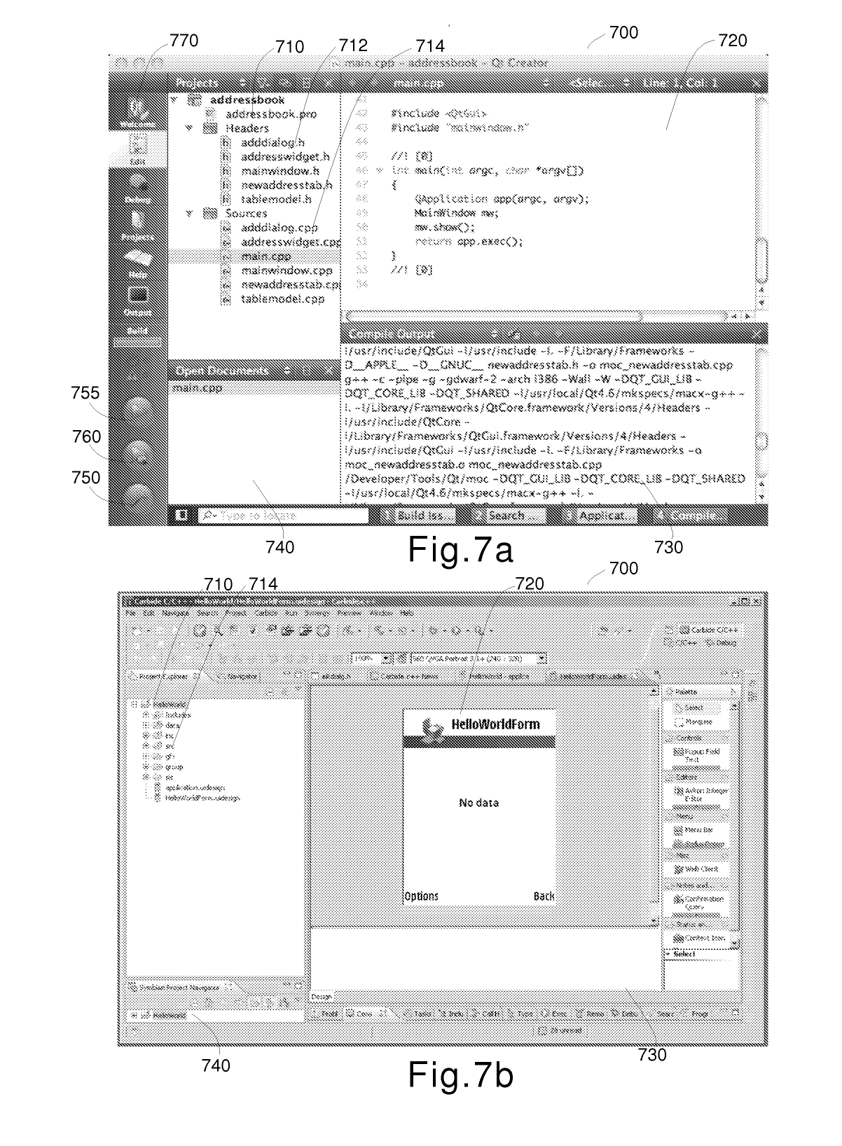

FIGS. 7a and 7b show development environments according to an example embodiment. A development environment 700 comprises different areas for showing different parts of the project under development. The files of the project like the project definition files 710, header files 712, user interface definition files and the program files 714, or any other files that may be understood to be source code files, may be shown in the project window 710. The contents of any of these files may be shown in the edit window 720, for example, in textual format that may be suitable for editing source code or in graphical format that may be suitable for editing user interface definitions. The result of compilation and linking may be shown in one window 730 and the currently opened documents in another window 740. There may be a button 750 and/or a menu option for compiling the project, a button 755 and/or a menu option for running the project and a button 760 and/or a menu option for debugging the project. The different views of the development environment may be controlled from a view pane 770 for switching between different views.

The above description of a development environment may apply to any known development environment, for example the Qt development environment by Nokia or the Carbide development environment. In an example embodiment, the operation of such a development environment is modified from what is currently known. For example, the source files may be provided to be visible from another location, and they may be received from a compilation server in the form of a skeleton project. The compilation may happen so that when the compilation button 750 is pressed, the project is sent to the compilation server for compilation. Subsequently, binary code may be received from the compilation server. There may also be a separate button for such sending.

The running of the project or the resulting application may happen so that when the button 755 or another button or menu option for this purpose is pressed, a binary code received from the compilation server is launched. The debugging or testing of the project may happen so that when the compilation server has compiled the program to binary code, the binary code is delivered to a testing server. This may happen by pressing the button 760 or another button or menu option for this purpose. The development environment may then form a data connection with the testing server and the remote device that executes the binary code is brought to be visible to the developer.

The development may also happen so that some or parts of the above operations are performed locally at the development machine, and parts or all of the operations are carried out at the server. The user interface of the development environment may be provided by a web interface, whereby the development environment may reside at a server. Some of the compilation, linking or building the installation package may happen at the local machine, or some or all may happen at the server.

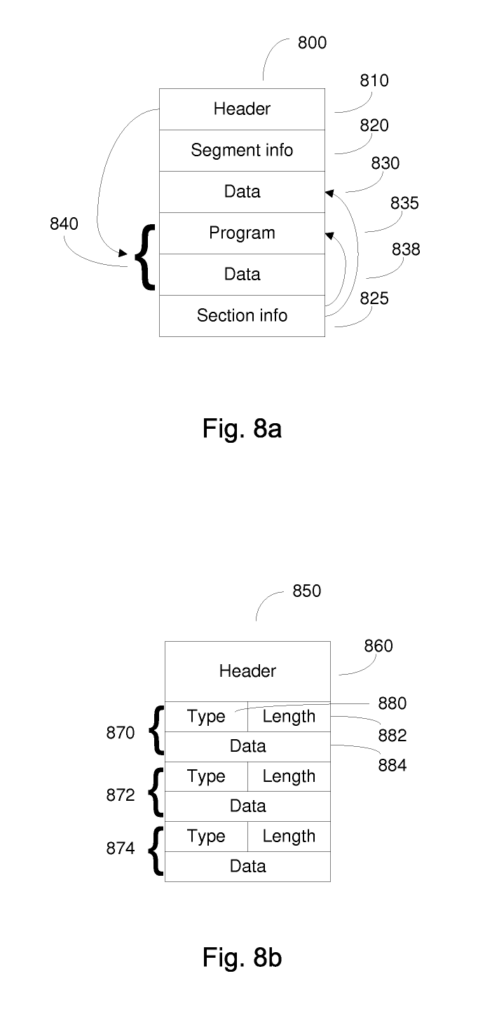

FIG. 8a shows a structure of a binary program according to an example embodiment. The binary program 800 may be in a form of a file or in a format of a file collection. The binary program may comprise a header 810, e.g. for indicating which platform the binary program is intended for, and for indicating the structure of the binary program. There are different formats for executable programs, e.g. a.out for Unix platforms, Common Object File Format (COFF), Executable and Linkable Format (ELF), Mach-O format for Apple OSX operating system, Portable Executable (PE) for Windows Platforms, System Object Model (SOM), DOS MZ format and COM format, and others. The binary program header may comprise information 820 on segments 840 used during execution of the binary program, and information 825 on sections 830, 835 and 838 used for example for linking.

FIG. 8b shows a structure of an installation package according to an example embodiment. The installation package 850 may contain a header 860 containing information on the target platform and the contents of the installation package. The installation package may comprise entries 870, 872 and 874 for holding data and (binary) program code. The entries may comprise a type indicator 880 showing the type of the contents in that entry, a length indicator 882 indicating the length of the data, and a data portion containing the data or program code. Installation packages may be embedded within each other.

The example embodiments described herein may provide advantages. For example, it may be easier to start development, because it is not necessary to configure the right development environment by hand. This may yield more time for the development, for example about 25% more time may be used for development instead of configuring the development and compilation environment. Promoting a testing service may allow users to test the binary code on a real target hardware instead of an emulator, which may helps to achieve better quality of the resulting software. The arrangements described here may support multiple platforms at the same time.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-25. (canceled)

26. A method comprising:
accessing target platform information at a compiler apparatus on a first communication interface, the target platform being external to the compiler apparatus;
accessing source code at the compiler apparatus on a second communication interface;
determining a compilation environment based on the target platform information;
forming a binary computer program from the source code for the target platform using the compilation environment; and
providing the binary computer program for the target platform available on a third communication interface.

27. A method according to claim 26 further comprising providing a source code template available on the second communication interface based on the target platform information.

28. A method according to claim 27 further comprising:
forming an installation package for the target platform using the binary computer program;
signing the installation package using the target platform information; and
providing the signed installation package available on the third communication interface.

29. A method according to claim 26 further comprising:
determining a testing environment based on the target platform information for testing the binary computer program; and
testing the binary computer program for correct operation of at least one of the group of installation, launch, input and output and user interface operation.

30. A method according to claim 26 further comprising:
providing the testing environment at least partially available on communication interface to a developer computer for receiving input from the developer computer and providing output to the developer computer.

31. A method according to claim 26, wherein the compilation environment comprises one or more of virtual machine, physical machine, compiler installation and compiler setup.

32. A method according to claim 26, wherein:
the first communication interface is an interface between the compiler apparatus and the developer computer;
the second communication interface is an interface between the compiler apparatus and a source code storage apparatus; and
the third communication interface is an interface between the compiler apparatus and the developer computer.

33. A method according to claim 26, wherein the first communication interface and the second communication interface are interfaces between the compiler apparatus and a development environment at the development computer, and the source code is provided by the development environment to the compiler apparatus by transmitting the source code file from the development computer to the compiler apparatus.

34. An apparatus comprising at least one processor, a memory including a computer program code, the memory and the computer program code configured to, with the processor, cause the apparatus at least to: access target platform information at a compiler apparatus on a first communication interface, the target platform being external to the compiler apparatus;
access a source code at the compiler apparatus on a second communication interface;
determine a compilation environment based on the platform information;
form a binary computer program from the source code for the target platform using the compilation environment; and
provide the binary computer program for the target platform available on a third communication interface.

35. An apparatus according to claim 34, wherein the apparatus is further caused to:
provide a source code template available on the second communication interface based on the target platform information.

36. An apparatus according to claim 35, wherein the apparatus is further caused to:
form an installation package for the target platform using the binary computer program;
sign the installation package using the target platform information; and
provide the signed installation package available on the third communication interface.

37. An apparatus according to claim 34, wherein the apparatus is further caused to:
determine a testing environment based on the target platform information for testing the binary computer program; and
test the binary computer program for correct operation of at least one of the group of installation, launch, input and output, and user interface operation.

38. An apparatus according to claim 34, wherein the apparatus is further caused to:
provide the testing environment at least partially available on communication interface to a developer computer so that the testing environment receives input from the developer computer and provides output to the developer computer.

39. An apparatus according to claim 34, wherein the compilation environment comprises at least one of the group of a virtual machine, physical machine, compiler installation, and compiler setup.

40. An apparatus according to claim 34, wherein: the first communication interface is an interface between the compiler apparatus and a developer computer;
the second communication interface is an interface between the compiler apparatus and a source code storage; and
the third communication interface is an interface between the compiler apparatus and the developer computer.

41. An apparatus according to claim 34, wherein the first communication interface and the second communication interface are interfaces between the compiler apparatus and a development environment at the development computer, and the compiler apparatus is configured to receive the source code from the development environment by receiving a source code file from the development computer to the compiler apparatus.

42. An apparatus comprising at least one processor, memory including computer program code, the memory and the computer program code configured to, with the processor, cause the apparatus to perform at least:
provide target platform information available for a compiler apparatus on a first communication interface, the target platform being external to the compiler apparatus;
receive a source code template, the template having been formed based on the target platform information;
form source code using the source code template and provide the source code available for a compiler apparatus on a communication interface; and
receive a binary computer program formed from the source code for the target platform, the binary computer program having been formed by determining the target platform based on the target platform information.

43. A computer program product stored on a computer readable medium and executable in a data processing device, the computer program product comprising:
a computer program code section for accessing target platform information at a compiler apparatus on a first communication interface, the target platform being external to the compiler apparatus;
a computer program code section for accessing source code at a compiler apparatus on a second communication interface;
a computer program code section for determining a compilation environment based on said platform information;
a computer program code section for forming a binary computer program from said source code for said target platform using said compilation environment; and
a computer program code section for providing the binary computer program for the target platform available on a third communication interface.

44. A computer program product according to claim 43 further comprising a computer program code section for providing a source code template available on the second communication interface based on the target platform information.

45. A computer program product according to claim 44 further comprising:
a computer program code section for forming an installation package for the target platform using the binary computer program;
a computer program code section for signing the installation package using the target platform information; and
a computer program code section for providing the signed installation package available on the third communication interface.
